(19) United States
(12) Patent Application Publication
(10) Pub. No.: US 2015/0370760 A1
(43) Pub. Date: Dec. 24, 2015

(54) METHODS, SYSTEMS, AND MEDIA FOR PRESENTING A DOCUMENT ON A SCREEN

(71) Applicant: The Speed Reading Group, Chamber of Commerce number: 60482605, Amsterdam (NL)

(72) Inventor: Mark Sybren Tigchelaar, Amsterdam (NL)

(21) Appl. No.: 14/493,773

(22) Filed: Sep. 23, 2014

Related U.S. Application Data
(60) Provisional application No. 62/014,560, filed on Jun. 19, 2014.

(51) Int. Cl. G06F 17/21; G06F 17/30

(52) U.S. Cl. CPC G06F 17/214; G06F 17/212; G06F 17/30613

(57) ABSTRACT

In accordance with some embodiments of the disclosed subject of matter, mechanisms for presenting a document on a screen are provided. In some embodiments, methods for presenting a document on a screen are provided, the methods comprising: evaluating a first importance value of a first portion of a document to be read; associating a first index with the first portion of the document according to the first importance value; generating a first instruction based on the first index for formatting the first portion of the document to the user on a screen; and presenting the first portion of the document on the screen based on the first instruction.

### CROSS-REFERENCE TO RELATED APPLICATIONS

This application claims the benefit of U.S. Provisional Patent Application No. 62/014,560, filed Jun. 19, 2014, which is hereby incorporated by reference herein in its entirety.

### TECHNICAL FIELD

The disclosed subject matter relates to methods, systems, and media for presenting a document on a screen.

### BACKGROUND INFORMATION

Many people scan or skim documents (e.g., articles, works of fiction, textbooks, newspapers, magazines, etc.) on a screen. They move their eyes diagonally across the screen to see if they want to read the information. However, studies have shown that only around 5% of the information can be captured by a quick scanning or skimming and some important information could be missed. Therefore, presenting a document directly may not be a time-effective way for a user to read.

Accordingly, it is desirable to provide new mechanisms for presenting a document on a screen.

### SUMMARY

In accordance with some embodiments of the disclosed subject of matter, mechanisms for presenting a document on a screen are provided. In some embodiments, methods for presenting a document on a screen are provided, the methods comprising: evaluating a first importance value of a first portion of a document to be read; associating a first index with the first portion of the document according to the first importance value; generating a first instruction based on the first index for formatting the first portion of the document to the user on a screen; and presenting the first portion of the document on the screen based on the first instruction.

In some embodiments, a system for presenting a document on a screen is provided, the system comprising: a hardware processor that is programmed to: evaluate a first importance value of a first portion of a document to be read; associate a first index with the portion of the document according to the importance value; generate a first instruction based on the first index for formatting the first portion of the document to the user on a screen; and present the first portion of the document on the screen based on the first instruction.

In some embodiments, a non-transitory computer-readable medium containing computer-executable instructions that, when executed by a processor, cause the processor to perform a method for presenting a document on a screen is provided, the method comprising: evaluating a first importance value of a first portion of a document to be read; associating a first index with the portion of the document according to the importance value; generating a first instruction based on the first index for formatting the first portion of the document to the user on a screen; and presenting the first portion of the document on the screen based on the first instruction.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is an example of a system for presenting a document on a screen in accordance with some embodiments of the disclosed subject matter.

FIG. 2 is an example of hardware that can be used in a server and/or a computing device in accordance with some embodiments of the disclosed subject matter.

FIG. 3 shows a flow chart of an example of a process for presenting a document on a screen in accordance with some embodiments of the disclosed subject matter.

FIG. 4 shows an example of a user interface presenting a document on a screen in accordance with some embodiments of the disclosed subject matter.

### DETAILED DESCRIPTION

In accordance with various embodiments, as described in more detail below, mechanisms, which can include methods, systems, and computer-readable media, for presenting a document on a screen are provided.

In some embodiments, these methods, systems, and media can evaluate importance values of multiple words, phrases, and/or sentences within a document being presented to a user. Such importance values can be determined based on word analysis. For example, if a sentence includes one or more signal words and/or phrases (e.g., “important,” “essential,” “as a result,” “in summary,” etc.), the sentence can be evaluated to be a sentence with a high importance value. As another example, if a word or a phrase is related to a keyword of a document, the word or the phrase can be evaluated as a word or a phrase with a high importance value. As yet another example, if one or more words are located between a pair of brackets, the one or more words can be evaluated as words with a low importance value. In some embodiments, one or more words, phrases, and/or sentences can be associated with index numbers based on their corresponding importance values.

In some embodiments, the methods, systems, and media described herein can format and present a document in stratified ways such that words, phrases, and/or sentences with different index numbers in the document can be distinguished from each other. For example, one or more words, phrases, and/or sentences that include important messages can be highlighted, while one or more words, phrases, and/or sentences containing less important messages can be presented by an inconspicuous color, and one or more words, phrases, and/or sentences with irrelevant information can be blurred. This can allow a user to capture the most important information of the document more quickly, and/or with increased reading comprehension than if the user were to read the document without the new presentation being applied using the methods, systems, and media described herein.

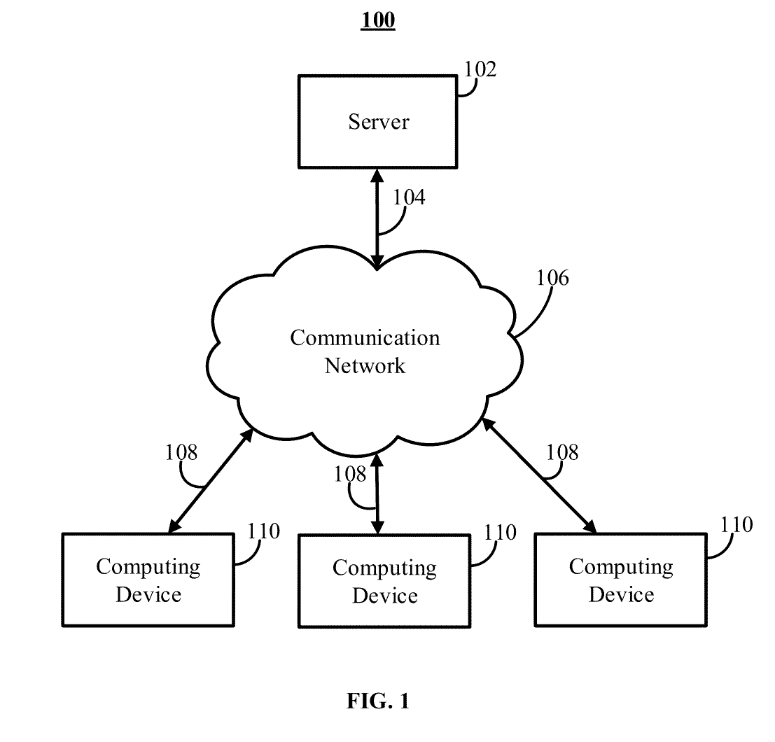

FIG. 1 shows an example of a generalized schematic diagram of a system 100 in which the mechanisms for presenting a document on a screen as described herein can be implemented in accordance with some embodiments. As illustrated, system 100 can include one or more computing devices 110. Computing devices 110 can be local to each other or remote from each other. Computing devices 110 can be connected by one or more communications links 108 to a communications network 106 that can be linked via a communications link 104 to server 102.

In some embodiments, system 100 can include one or more servers 102. Each server 102 can be any suitable server for providing access to the mechanisms described herein or for providing copies of an application or a portion of an application (e.g., a computer program or portion of a computer program) for utilizing the mechanisms described herein for presenting a document on a screen, such as a hardware processor, a computer, a data processing device, or any suitable combination of such devices. For example, the mechanisms for presenting a document on a screen can be distributed into multiple backend components and multiple frontend components and/or interfaces. In a more particular example, backend components, such as data collection, data distribution, document synchronization, etc., can be performed on one or more servers 102. In another particular example, frontend components, such as a user interface, importance evaluation of words and sentences, presentation of documents, etc., can be performed on one or more computing devices 110.

In some embodiments, each of the computing devices 110, and server 102 can be any of a general purpose device such as a computer or a special purpose device such as a client, a server, etc. Any of these general or special purpose devices can include any suitable components such as a hardware processor (which can be a microprocessor, digital signal processor, a controller, etc.), memory, communication interfaces, display controllers, input devices, etc. For example, computing device 110 can be implemented as a personal computer, a laptop computer, a smartphone, a wearable computer, a tablet computer, a gaming device, a server, etc., or any suitable combination thereof.

Communications network 106 can be any suitable computer network or combination of such networks including the Internet, an intranet, a wide-area network (WAN), a local-area network (LAN), a wireless network, a digital subscriber line (DSL) network, a frame relay network, an asynchronous transfer mode (ATM) network, a virtual private network (VPN), etc. Communications links 104 and 108 can be any communications links suitable for communicating data among computing devices 110 and server 102, such as network links, dial-up links, wireless links, hard-wired links, any other suitable communications links, or any suitable combination of such links. Computing devices 110 and server 102 can be located at any suitable location.

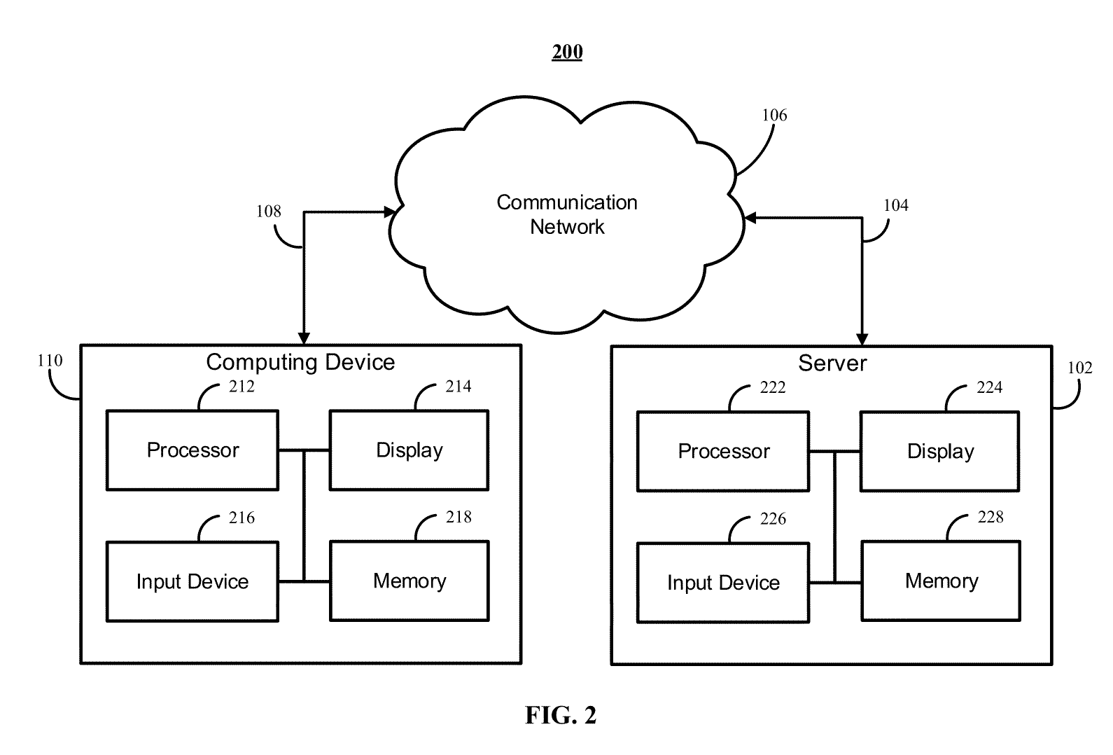

FIG. 2 illustrates an example 200 of hardware that can be used to implement server 102 and one of the computing devices 110 depicted in FIG. 1 in accordance with some embodiments of the disclosed subject matter. Referring to FIG. 2, computing device 110 can include a hardware processor 212, a display 214, an input device 216, and memory 218, which can be interconnected. In some embodiments, memory 218 can include a storage device (such as a non-transitory computer-readable medium) for storing a computer program for controlling hardware processor 212.

Hardware processor 212 can use the computer program to execute the mechanisms described herein, including: receiving data of a document to be presented, evaluating importance values of sentences in the document, generating instructions to present sentences on display 214, sending and/or receiving data through communications link 108, and/or performing any other suitable actions. Display 214 can be a flat panel display (e.g., an LED display, an OLED display, a plasma display, etc.), a cathode ray tube display, a projector, a touchscreen, a speaker(s), and/or any other suitable display and/or presentation devices. Input device 216 can be a computer keyboard, a computer mouse, a microphone, a touchpad, a voice recognition circuit, a touchscreen, and/or any other suitable input device.

Server 102 can include a hardware processor 222, a display 224, an input device 226, and memory 228, which can be interconnected. In some embodiments, memory 228 can include a storage device for storing data received through communications link 104 or through other links. The storage device can further include a server program for controlling hardware processor 222.

Hardware processor 222 can use the server program to communicate with computing devices 110, as well as to provide access to and/or copies of the mechanisms described herein. Display 224 can be a flat panel display, a cathode ray tube display, a projector, a touchscreen, a speaker(s), and/or any other suitable display and/or presentation devices. Input device 226 can be a computer keyboard, a computer mouse, a touchpad, a voice recognition circuit, a touchscreen, and/or any other suitable input device.

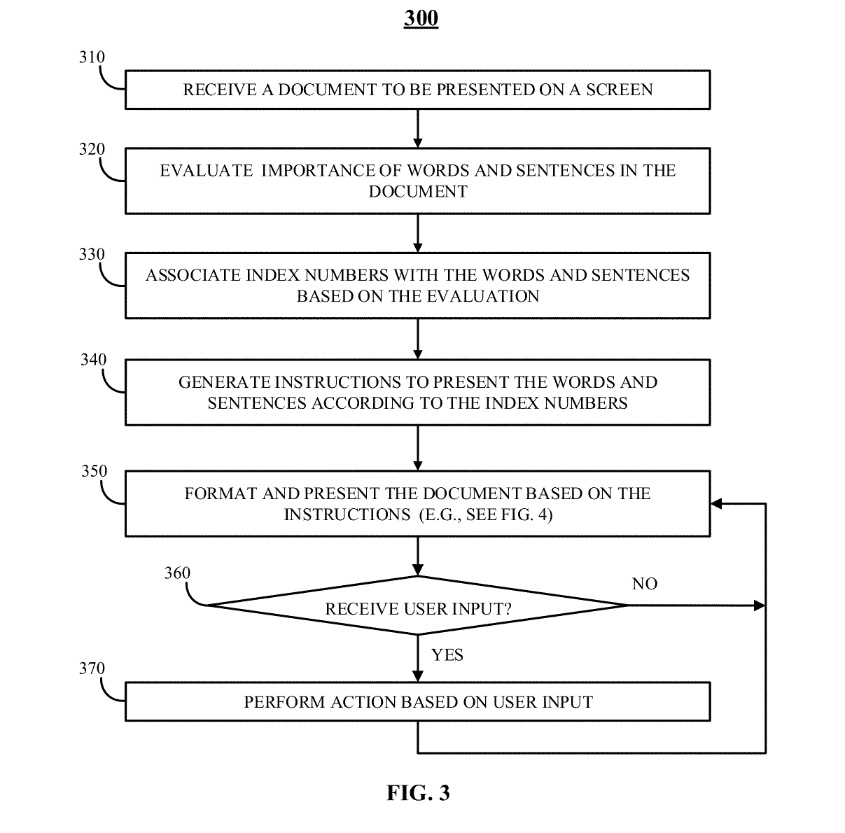

FIG. 3 shows an example 300 of a process 300 for presenting a document on a screen in accordance with some embodiments of the disclosed subject matter. In some embodiments, process 300 can be executed as part of an application for presenting documents on a screen (e.g., a document presenting application, a Web Browser application, etc.) and can be used whenever a document is being presenting using the application. For example, process 300 can be executed as part of an application for presenting documents on a computing device (e.g., a computing device 110 shown in FIG. 1). As another example, process 300 can be executed as a plug-in, add-on, extension, or other additional software that can act in concert with other software, such MICROSOFT WORD, ADOBE READER, ADOBE ACROBAT, MOZILLA FIREFOX Web browser, GOOGLE CHROME Web Browser, or any other document editing and/or reading software.

Process 300 can begin by receiving a document to be presented on a screen using the mechanisms described herein at 310. A document to be presented on a screen can be received using any suitable technique(s). For example, in response to a user selection, process 300 can receive a document to be presented from a library of documents that is contained in an application executing process 300. As another example, process 300 can receive a document to be presented based on a user selection of a document from a website when an application executing process 300 is running. As yet another example, when process 300 is executed as a plug-in, add-on, extension, or other additional software that can act in concert with another software, process 300 can receive a document to be presented based on a user selection of a document using the other software.

In some embodiments, a document to be presented can be received from a library of documents associated with a user. Such a library of documents can contain documents that are imported from or opened from another application, purchased through an application executing process 300, etc. As described below, such a library of documents can be organized and/or searched using any suitable technique.

In some embodiments, any suitable document can be imported into an application executing process 300 and can be automatically added to the library upon importing such a document. In such embodiments, documents can be imported form any suitable source, such as: DROPBOX; GOOGLE DRIVE; BOX; SKYDRIVE; SUGARSYNC; WEBDAV-SERVER; SFTP; OFFICE 365 SHAREPOINT; MYDISK.SE; FILESANYWHERE; STOREGATE; CLOUDME; a Web page or Web site; READ IT LATER; EVERNOTE; SHELFARI; INSTAPAPER; REEDER; an RSS feed; an email server (e.g., the application can be assigned an email address to which documents to be added to the library can be sent); etc.

In some embodiments, a document to be presented can be in any suitable format and can include text, formatting information (e.g., different fonts, line spacing, bolding, italics, margins, etc.), images, video, and any other suitable information. Examples of document formats that can be used by process 300 can include: Portable Document Format (PDF) format; a plain text format such as ASCII, UTF-8, etc.; Amiga Guide format; Microsoft Word format (e.g., using file extension “.doc”); DjVu format; Office Open XML format (e.g., using file extension “.docx”); Open Document format (e.g., using file extension “.odt”); Open XML Paper Specification (OXPS) format; DocBook format (e.g., an XML format typically used for technical documentation); HTML (e.g., using extension “.html” or “.htm”); FictionBook format (e.g., using file extension “.fb2”); Pages Postscript format (e.g., using file extension “.ps”); Rich Text Format (RTF); TeX format; TEI format; Troff format; Uniform Office Format (e.g., a standard Chinese format); WordPerfect format (e.g., using file extension “.wpd,” “.wp,” “.wp7,” etc.); electronic publication (EPUB) format; AZW format; KF8 format; or any other suitable format or combination of formats.

At 320, process 300 can evaluate the importance of words and sentences in the received document. Any suitable technique(s) and/or factor(s) can be used to evaluate the importance of a word, a phrase, and/or a sentence. In some embodiments, the importance of a word, a phrase, and/or a sentence can be evaluated based on the formatting of a document. For example, one or more words, phrases, and/or sentences that relate to the structure of a document, such as a title and/or subtitle of the document, titles of sections and/or subsections, abstract of the document, conclusion sentence(s), etc. can be evaluated to determine their importance. As another example, one or more words, phrases, and/or sentences that are emphasized, such as bold text, italic text, underlined text, text written in capitals, text in a different color, highlighted text, etc. can be evaluated to determine their importance. As yet another example, one or more words, phrases, and/or sentences that are associated with an image, a graph, a table, and/or a list of the document can be evaluated to determine their importance.

In some embodiments, the importance of a word, a phrase, and/or a sentence can be evaluated based on word analysis. For example, if a word is a noun or a number, the word can be evaluated as an important word. Similarly, if a phrase or a sentence contains a noun or a number, the phrase or the sentence can be evaluated as important. As another example, if a word or a phrase is contained an enumeration, or a sentence is located before an enumeration (e.g., an enumerated list), the word/phrase/sentence can be evaluated as important. As yet another example, one or more words, phrases, and/or sentences that describe an image, a graph, a table, and/or a list of the document can be evaluated as important.

As still another example, one or more words, phrases, and/or sentences that contain a word within a signal words list can be evaluated as important. The signal words list can include any suitable words. For example, the signal words list can include any suitable signal words and/or phrases that indicate a conclusion, such as “consequently,” “finally,” “therefore,” “as a result,” “above all,” “in summary,” etc. As another example, the signal words list can include any suitable signal words and/or phrases that indicate emphasis, such as “important,” “significant,” “especially,” “essential,” “key point,” “remember that,” “major development,” “a primary concern,” etc. In some embodiments, a signal words list can be determined using any suitable technique(s). For example, a signal words list can be predetermined by a user in a settings portion of an application executing process 300. As another example, a signal words list can be determined and/or modified using one or more machine learning techniques.

As still another example, one or more words, phrases, and/or sentences that relate to one or more keywords of the document can be evaluated as important. In such an example, a word related to a keyword can be a synonym word of a keyword, a hypernym word of a keyword, a hyponym word of a keyword, a word within a phrase/sentence that describes a keyword, and/or a word that has any suitable relationship with the keyword. Similarly, a phrase/sentence being related to a keyword can mean that the phrase/sentence contains a word that is related to the keyword. In some embodiments, one or more keywords of the document can be determined by any suitable technique(s). For example, one or more words that relate to the title, the subtitle, the abstract sentence(s), and/or the conclusion sentence(s) of the document can be determined to be the keywords of the documents. As another example, one or more keywords can be determined based on statistical information of the words in the document.

In some embodiments, the importance of a word, a phrase, and/or a sentence can be evaluated based on additional information of the document. For example, if a word/phrase/sentence in the document has been highlighted more than N (a pre-determined number) times by other readers, the word/phrase/sentence can be evaluated as important. As another example, if the document is a search result returned in response to a search query of a user, one or more words, phrases, and/or sentences that relate to the search query can be evaluated as important.

In some embodiments, one or more words, phrases, and/or sentences can be evaluated as not important and/or irrelevant by process 300. For example, if one or more words, phrases, and/or sentences that are located between a pair of punctuation marks, such as a pair of quotes, a pair of double quotes, a pair of parentheses, a pair of brackets, a pair of braces, a pair of angle brackets, etc., the one or more words, phrases, and/or sentences can be evaluated as not important and/or irrelevant. As another example, if one or more words, phrases, and/or sentences are located after a trigger word or phrase, punctuation, and/or abbreviation, such as “for example,” “just as,” “such as,” “by way of illustration,” a colon, “e.g.,” “inter alia,” “i.a.,” etc., the one or more words, phrases, and/or sentences can be evaluated as not important and/or irrelevant.

At 330, process 300 can associate index numbers with the words and sentences in the document based on the evaluation. In some embodiments, one or more factors that are used to determine the importance of words and sentences can be numerically scored and/or weighted using any suitable scale, and the resulting weighted scores can be combined in any suitable way to determine the importance of a word, a phrase, and/or a sentence.

For example, process 300 can set three levels of importance for a word, a phrase, and/or a sentence. In such an example, any suitable words, phrases, and/or sentences that have been evaluated as being of a given level of importance (e.g., bolded words, italicized words, keywords, highlighted phrases, underlined sentences, sentences containing signal words, etc.) can be associated with index numbers with a value of 2. In such an example, any suitable words, phrases, and/or sentences that have been evaluated as less important (e.g., descriptions of images and/or graphics, words/phrases/sentences that relate to a word/phrase/sentence with an index number associated with a value of 2, etc.) can be associated with index numbers with a value of 1. In such an example, any suitable words, phrases, and/or sentences that have been evaluated as unimportant and/or irrelevant (e.g., a phrase located between a pair double quotes, a word located between a pair of brackets, a sentence located after “for example,” a sentence located before “etc.,” etc.) can be associated with index numbers with a value of 0.

As another example, process 300 can set three levels of importance for a word and/or a phrase as discussed above, and then determine an importance value for a sentence based on the importance levels of one or more words and/or phrases in the sentence. In a more particularly example, an importance value for a sentence can be calculated by adding up the values of index numbers associated with every words and/or phrases in the sentence, and then dividing the summation by the total number of words and/or phrases in the sentence. In such particularly example, the sentence can be associated with an index number with the calculated importance value.

At 340, process 300 can generate instructions to present the words and sentences according to the corresponding index numbers. In some embodiments, the instructions can cause words and/or sentences with different index numbers to be presented in different formats, thereby allowing a reader to distinguish the importance levels of the words and/or sentences. For example, the instructions can cause words and/or sentences with different index numbers to be presented in different colors, in different fonts, and/or in different font sizes. As another example, the instructions can cause words and/or sentences with different index numbers to be presented with different brightness levels, resolutions and/or definitions.

At 350, based on the instructions, process 300 can format the document received at 310 for presentation, and cause the formatted document to be presented on a screen. In some embodiments, any suitable user interface (e.g., a browser window, a Web page, a document presenting interface, etc.) can be used to present the document on a screen based on the instructions through an application executing process 300.

In some embodiments, process 300 can format and present the document based on the instructions generated at 340. In response to the instructions, words and/or sentences in the document with different index numbers can be formatted and presented using different formatting rules. For example, the most important words and/or sentences (e.g., words and/or sentences associated with index numbers with a value of 2) can be formatted and presented with a large font size, the less important words and/or sentences (e.g., words and/or sentences associated with index numbers with a value of 1) can be formatted and presented with an intermediate font size, and the unimportant and/or irrelevant words and/or sentences (e.g., words and/or sentences with index numbers with a value of 0) can be formatted and presented with a small font size.

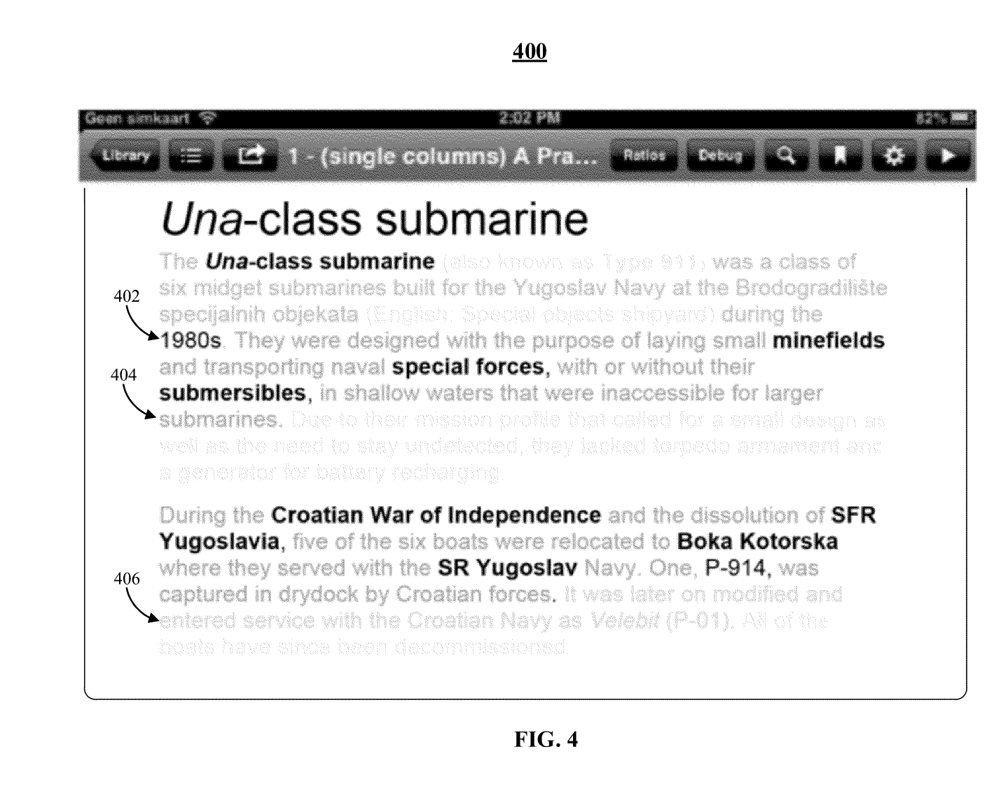

As another example, as illustrated in FIG. 4, the most important words and/or sentences 402 (e.g., words and/or sentences associated with index numbers with a value of 2) can be formatted with a darkest color in a grayscale and can be presented without any blurring, the less important words and/or sentences 404 (e.g., words and/or sentences associated with index numbers with a value of 1) can be formatted with an intermediate color in the grayscale and can be presented with some blurring, and the unimportant and/or irrelevant words and/or sentences 406 (e.g., words and/or sentences associated with index numbers with a value of 0) can be formatted with a lightest color in the grayscale and can be presented with more blurring compared to the important and less important words and/or sentences.

In some embodiments, process 300 can format and present the document based on any other suitable factors. For example, process 300 can format and present the document using predetermined formatting rules (e.g., line spacing, text color, background color, page width, breaking text into two columns, page breaks, etc.) that promote a positive effect on reading speed, reading comprehension, concentration and reading comfort of a reader in some cases. In such an example, the predetermined formatting rules can be selected based on receiving a selection of options from the user through a settings portion of an application executing process 300. As another example, process 300 can format and present the document based on software and/or hardware of a device executing process 300 such that the document can be displayed to a user. In a more particular example, the document can be formatted such that it is caused to be presented by the device executing process 300 so that it is presented in the same way as the document would be displayed on another device having a different hardware and/or software configuration.

At 360, process 300 can determine if a user input has been received. User input can be received in any suitable form such as from a touchscreen of a computing device, from a pointing device coupled to a computing device, from a voice recognition circuit for recognizing voice commands, etc. Additionally, any suitable user input can be detected, for performing any suitable action within an application executing process 300. For example, a user input can be received to browse for content, change a presentation style of a word and/or a sentence, navigate to a home screen of an application executing process 300, navigate to or open a library of documents available for selection, change a page (e.g., by going to a next or previous page), scroll within a page (e.g., scrolling up, down, left or right in a page that is larger than the portion of a screen displaying the page), etc.

If an input from the user has not been received (“NO” at 360), process 300 can return to 350 and continue presenting the document to the user based on the instructions. Otherwise, if process 300 determines that a user input has benn received (“YES” at 360), process 300 can proceed to 370.

At 370, process 300 can perform an action based on the user input received at 360. As described above, any suitable action can be performed in response to receiving an input at 360. For example, in some embodiments, if process 300 is being executed in an application of a computing device, moving a pointer from a pointing device or a touchscreen over a word or a sentence that is presented with blurring (e.g., word 404, sentence 406, in connection with FIG. 4) can cause process 300 to remove the blur and show the sentence in a clear presentation.

In some embodiments, process 300 can receive an input that corresponds to a command to navigate to a next (or previous) page. For example, a swipe from right to left in the document can indicate that the next page is to be presented, and a swipe from left to right in the document can indicate that the previous page is to be presented. As another example, a double tap on a right side of the document can indicate that the next page is to be presented, and a double tap on the left side of the document can indicate that the previous page is to be presented. Any other suitable inputs can correspond to a command to navigate to a next or previous page, and may be included in a toolbar of the application executing process 300.

In some embodiments, an application executing process 300 can receive a user input to add user generated content such as notes, highlighting and/or other comments into the document, which can be saved in the document or in a separate file, such as a separate text file that corresponds to the selected document. In some embodiments, receiving a swipe gesture from left to right in the text (in cases where the application is running on a computing device having a touchscreen) can cause the portion of the text swiped over to be highlighted. In some cases, in order to highlight, the user may be required to hold a finger (or stylus, or other instrument, etc., capable of activating a touchscreen) at the beginning of the portion of the text to be highlighted, and then swipe to the end of the portion of the text to be highlighted. In some embodiments, receiving a swipe gesture from right to left in the text (in cases where the application is running on a computing device having a touchscreen) at a highlighted portion can cause a highlight to be removed from a portion of the text corresponding to the swipe. A similar operation can be performed with a pointing device (e.g., by clicking and dragging). Additionally, a user input corresponding to a bookmarking action, can be received which can cause a particular page or portion of the document to be bookmarked.

In some embodiments, user highlighted portions, comments and/or user notes can automatically be saved in a separate document (e.g., in a document with file extension .doc, .docx, .txt, .html, etc.), which can be viewed separately from the document to which it corresponds. This can provide a summary of notes and/or highlights added to the document by the user.

In some embodiments, in response to a user input, process 300 can provide a search function for the library of documents, which can use keywords to find documents in the library of documents, and then present search results using any suitable format (e.g., a list, icons, tiles, cover art, etc.) and in any suitable order. For example, if a keyword search has been performed, only documents containing the keyword(s) may be presented, or all documents may be presented with emphasis on the documents containing the keyword(s). In a more particular example, documents can be presented based on the following order: (1) documents in which the keyword is in the title; (2) documents in which the keyword is in the body of the document; (3) documents with a higher number of occurrences of the keyword or documents with a greater prominence in the title and/or body; (4) documents that were presented more recently; (5) documents that were created and/or added to a library more recently (e.g., based on the publication date of the document, based on the date the document was added to the user's library, based on the date that the file was created, etc.), and/or any other suitable criteria. Note that the library can be sorted using any other suitable techniques, such as alphabetically by author, by title, by size, etc.

In some embodiments, process 300 can initiate various actions related to a document in response to a user input received at 360, such as saving the document to a particular location (e.g., to a memory of a device rather than to the library), sharing the document (e.g., using social media, email, text messages, cloud storage, etc.), printing the document using any suitable printer, etc.

In some embodiments, a user's library of documents can be synchronized across multiple applications that use the mechanisms described herein (e.g., using the Internet, a LAN, etc.). The user's place in the document can be saved to the library, such that the user can access any documents in the user's library, and can start reading a document on one device, and continue reading on a different device. Additionally, a document can be reformatted when opened on a different device such that an appropriate format is used to present the document to the user based on the device being used to present the document (e.g., based on a screen size and/or resolution of the device, whether the device has a touchscreen, etc.).

After performing an action at 370, process 300 can return to 350 and continue presenting the document based on the instructions.

In some embodiments, the mechanisms described herein can include server-side software, client-side software, server-side hardware, client-side hardware, firmware, or any suitable combination thereof. For example, these mechanisms can encompass one or more Web pages or Web page portions (e.g., via any suitable encoding, such as Hyper Text Markup Language (“HTML”), Dynamic Hyper Text Markup Language (“DHTML”), Extensible Markup Language (“XML”), JavaServer Pages (“JSP”), Active Server Pages (“ASP”), Cold Fusion, or any other suitable approaches). As another example, these mechanisms can encompass a computer program that causes a processor to execute the user input interface application. For instance, these mechanisms can encompass a computer program written in a programming language recognizable by computing device 110 and/or server 102 that is executing the mechanisms (e.g., a program written in a programming language, such as, Java, C, Objective-C, C++, C#, JavaScript, Visual Basic, HTML, XML, Cold Fusion, any other suitable approaches, or any suitable combination thereof).

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

It should be understood that the above described steps of the process of FIG. 3 can be executed or performed in any order or sequence not limited to the order and sequence shown and described in the figure. Also, some of the above steps of the process of FIG. 3 can be executed or performed substantially simultaneously where appropriate or in parallel to reduce latency and processing times. Furthermore, it should be noted that FIG. 3 is provided as an example only. At least some of the steps shown in the figure may be performed in a different order than represented, performed concurrently, or omitted.

It should also be noted that, as used herein, the term mechanism can encompass hardware, software, firmware, or any suitable combination thereof. The provision of the examples described herein (as well as clauses phrased as “such as,” “e.g.,” “including,” and the like) should not be interpreted as limiting the claimed subject matter to the specific examples; rather, the examples are intended to illustrate only some of many possible aspects. It should also be noted that, as used herein, the term mechanism can encompass hardware, software, firmware, or any suitable combination thereof.

Accordingly, methods, systems, and media for presenting a document on a screen are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

1. A method for presenting a document on a screen to a user, the method comprising:
determining a number of times a first portion of the document has been highlighted by users other than the user;
evaluating a first importance value of the first portion of the document to be read based at least on the number of times the first portion of the document has been highlighted by users other than the user;
associating a first index with the first portion of the document according to the importance value;
generating a first instruction based on the first index for formatting the first portion of the document to the user on the screen; and
presenting the first portion of the document on the screen based on the first instruction.

2. The method of claim 1, further comprising:
evaluating a second importance value of a second portion of the document, wherein the second importance value is not equal to the first importance value;
associating a second index with the second portion of the document according to the second importance value, wherein the second index is different from the first index;
generating a second instruction based on the second index for formatting the second portion of the document to the user on the screen, wherein the second instruction is different from the first instruction; and
presenting the second portion of the document on the screen based on the second instruction, wherein the presentation of the second portion of the document is different from the presentation of the first portion of the document.

3. The method of claim 1, further comprising changing the presentation of the first portion of the document in response to receiving a user input.

4. The method of claim 3, wherein the user input is moving a pointer over the first portion of the document.

5. The method of claim 1, wherein evaluating a first importance value of the first portion of the document is based on word analysis of the first portion of the document.

6. The method of claim 1, wherein the first instruction for formatting the first portion of the document further comprises at least one portion that:
sets a font of the first portion of the document to a particular font;
sets a font size of the first portion of the document to a particular font size;
sets a line spacing of the first portion of the document to a particular line spacing;
sets a text color of the first portion of the document to a particular color;
sets a background color of the first portion of the document to a particular background color;
sets a grayscale value of the first portion of the document to a particular grayscale value;
sets a brightness value of the first portion of the document to a particular brightness value;
sets a definition value of the first portion of the document to a particular definition value; and
sets a resolution value of the first portion of the document to a particular resolution value.

7. The method of claim 1, wherein the document includes at least one of: Portable Document Format (PDF) format; ASCII; UTF-8; Amiga Guide format; Microsoft Word format; DjVu format; Office Open XML format; Open Document format; Open XML Paper Specification (OXPS) format; DocBook format; HTML; FictionBook format; Pages Postscript format; Rich Text Format (RTF); TeX format; TEI format; Troff format; Uniform Office Format; WordPerfect format; electronic publication (EPUB) format; AZW format; and KF8 format.

8. A system for presenting a document on a screen to a user, the system comprising:
a hardware processor that is programmed to:
determine a number of times a first portion of the document has been highlighted by users other than the user;
evaluate a first importance value of the first portion of the document to be read based at least on the number of times the first portion of the document has been highlighted by users other than the user;
associate a first index with the first portion of the document according to the importance value;
generate a first instruction based on the first index for formatting the first portion of the document to the user on the screen; and
present the first portion of the document on the screen based on the first instruction.

9. The system of claim 8, wherein the hardware processor is further programmed to:
evaluate a second importance value of a second portion of the document, wherein the second importance value is not equal to the first importance value;
associate a second index with the second portion of the document according to the second importance value, wherein the second index is different from the first index;
generate a second instruction based on the second index for formatting the second portion of the document to the user on the screen, wherein the second instruction is different from the first instruction; and
present the second portion of the document on the screen based on the second instruction, wherein the presentation of the second portion of the document is different from the presentation of the first portion of the document.

10. The system of claim 8, wherein the hardware processor is further programmed to change the presentation of the first portion of the document in response to receiving a user input.

11. The system of claim 10, wherein the user input is moving a pointer over the first portion of the document.

12. The system of claim 8, wherein evaluating a first importance value of the first portion of the document is based on word analysis of the first portion of the document.

13. The system of claim 8, wherein the first instruction for formatting the first portion of the document further comprises at least one portion that:
sets a font of the first portion of the document to a particular font;
sets a font size of the first portion of the document to a particular font size;
sets a line spacing of the first portion of the document to a particular line spacing;
sets a text color of the first portion of the document to a particular color;
sets a background color of the first portion of the document to a particular background color;
sets a grayscale value of the first portion of the document to a particular grayscale value;
sets a brightness value of the first portion of the document to a particular brightness value;
sets a definition value of the first portion of the document to a particular definition value; and
sets a resolution value of the first portion of the document to a particular resolution value.

14. The system of claim 8, wherein the document includes at least one of: Portable Document Format (PDF) format; ASCII; UTF-8; Amiga Guide format; Microsoft Word format; DjVu format; Office Open XML format; Open Document format; Open XML Paper Specification (OXPS) format; DocBook format; HTML; FictionBook format; Pages Postscript format; Rich Text Format (RTF); TeX format; TEI format; Troff format; Uniform Office Format; WordPerfect format; electronic publication (EPUB) format; AZW format; and KF8 format.

15. A non-transitory computer-readable medium containing computer-executable instructions that, when executed by a processor, cause the processor to perform a method for presenting a document on a screen to a user, the method comprising:
determining a number of times a first portion of the document has been highlighted by users other than the user;
evaluating a first importance value of the first portion of the document to be read based at least on the number of times the first portion of the document has been highlighted by users other than the user;
associating a first index with the first portion of the document according to the importance value;
generating a first instruction based on the first index for formatting the first portion of the document to the user on the screen; and
presenting the first portion of the document on the screen based on the first instruction.

16. The non-transitory computer-readable medium of claim 15, wherein the method further comprises:
evaluating a second importance value of a second portion of the document, wherein the second importance value is not equal to the first importance value;
associating a second index with the second portion of the document according to the second importance value, wherein the second index is different from the first index;
generating a second instruction based on the second index for formatting the second portion of the document to the user on the screen, wherein the second instruction is different from the first instruction; and
presenting the second portion of the document on the screen based on the second instruction, wherein the presentation of the second portion of the document is different from the presentation of the first portion of the document.

17. The non-transitory computer-readable medium of claim 15, wherein the method further comprises changing the presentation of the first portion of the document in response to receiving a user input.

18. The non-transitory computer-readable medium of claim 17, wherein the user input is moving a pointer over the first portion of the document.

19. The non-transitory computer-readable medium of claim 15, wherein evaluating a first importance value of the first portion of the document is based on word analysis of the first portion of the document.

20. The non-transitory computer-readable medium of claim 15, wherein the first instruction for formatting the first portion of the document further comprises at least one portion that:
sets a font of the first portion of the document to a particular font;
sets a font size of the first portion of the document to a particular font size;
sets a line spacing of the first portion of the document to a particular line spacing;
sets a text color of the first portion of the document to a particular color;
sets a background color of the first portion of the document to a particular background color;
sets a grayscale value of the first portion of the document to a particular grayscale value;
sets a brightness value of the first portion of the document to a particular brightness value;
sets a definition value of the first portion of the document to a particular definition value; and
sets a resolution value of the first portion of the document to a particular resolution value.

21. The non-transitory computer-readable medium of claim 15, wherein the document includes at least one of: Portable Document Format (PDF) format; ASCII; UTF-8; Amiga Guide format; Microsoft Word format; DjVu format; Office Open XML format; Open Document format; Open XML Paper Specification (OXPS) format; DocBook format; HTML; FictionBook format; Pages Postscript format; Rich Text Format (RTF); TeX format; TEI format; Troff format; Uniform Office Format; WordPerfect format; electronic publication (EPUB) format; AZW format; and KF8 format.
